(19) United States
(12) Patent Application Publication
(10) Pub. No.: US 2024/0338600 A1
(43) Pub. Date: Oct. 10, 2024

(54) SYSTEM AND METHOD FOR AUTOMATICALLY GENERATING AND PRESENTING INSIGHT DATA IN FORM OF NATURAL LANGUAGE

(71) Applicant: Walmart Apollo, LLC, Bentonville, AR (US)

(72) Inventors: Venkataravikishore Talluri, Andhra Pradesh (IN); Abhisek Dutta, Kolkata (IN); Dhaval Sureshchandra Gandhi, Bangalore (IN); Somedip Karmakar, Bengaluru (IN)

(21) Appl. No.: 18/626,502

(22) Filed: Apr. 4, 2024

Related U.S. Application Data
(60) Provisional application No. 63/494,515, filed on Apr. 6, 2023.

(51) Int. Cl. G06N 20/00

(52) U.S. Cl. CPC G06N 20/00

(57) ABSTRACT

Systems and methods for automatically generating and presenting insight data in form of natural language are disclosed. In some embodiments, each of a plurality of data records is generated by applying a respective combination of filters on a dataset. For each data record, a corresponding one of N insight dimensions is determined. M data records are selected among data records corresponding to each insight dimension, to generate M*N data records. Using a reinforcement learning model, L data records are selected from the M*N data records. By applying a natural language model to each of the L data records, an insight data is generated in form of human readable language based on the corresponding insight dimension of the data record, and presented to a user together with the respective combination of filters applied to generate the data record.

### CROSS-REFERENCE TO RELATED APPLICATION

This application claims benefit to U.S. Provisional Application Ser. No. 63/494,515, entitled “SYSTEM AND METHOD FOR AUTOMATICALLY GENERATING AND PRESENTING INSIGHT DATA IN FORM OF NATURAL LANGUAGE,” filed on Apr. 6, 2023, the disclosure of which is incorporated herein by reference in its entirety.

### TECHNICAL FIELD

This application relates generally to data processing and conversion and, more particularly, to systems and methods for automatically generating and presenting insight data in form of natural language.

### BACKGROUND

People, in about every position of any business, look at many charts and dashboards every day, to take appropriate decisions and/or learn new ideas. In many dashboards which provide information on business-critical cases, charts are difficult to interpret. It takes lots of time and effort to unearth insights from the charts. Some very critical insights might be missed due to manual efforts in interpreting the charts. It has a learning curve and sometimes requires extensive trainings to understand and interpret specific charts.

In general, original data collected for learning or decision-making has a huge size and is not organized in a way to provide insights to users. As such, users have to navigate using a plethora of filter combinations to focus on specific parts of the data that may be of high importance. For example, a data presentation tool may describe visuals in a dashboard but is unable to identify the filter combinations or sections of data where the focus needs to be for users to understand the insights of data. It is left to the users themselves to drill down the data using a correct set of filter combinations based on users' own experience.

### SUMMARY

The embodiments described herein are directed to systems and methods for automatically generating and presenting insight data in form of natural language.

In various embodiments, a system including a non-transitory memory configured to store instructions thereon and at least one processor is disclosed. The at least one processor is configured to read the instructions to: generate a plurality of data records based on a dataset, wherein each of the plurality of data records is generated by applying a respective combination of filters on the dataset; determine, for each of the plurality of data records, a corresponding one of N insight dimensions; select, among data records corresponding to each of the N insight dimensions, M data records to generate M*N data records, wherein M and N are integers larger than one; select, using a reinforcement learning model, L data records from the M*N data records, wherein L is an integer larger than one and less than M*N; generate, by applying a natural language model to each of the L data records, an insight data in form of human readable language based on the corresponding insight dimension of the data record; and transmit, for each of the L data records, the insight data to be presented to a user together with the respective combination of filters applied to generate the data record.

In various embodiments, a computer-implemented method is disclosed. The computer-implemented method includes: generating a plurality of data records based on a dataset, wherein each of the plurality of data records is generated by applying a respective combination of filters on the dataset; determining, for each of the plurality of data records, a corresponding one of N insight dimensions; selecting, among data records corresponding to each of the N insight dimensions, M data records to generate M*N data records, wherein M and N are integers larger than one; selecting, using a reinforcement learning model, L data records from the M*N data records, wherein L is an integer larger than one and less than M*N; determining, by applying a natural language model to each of the L data records, an insight data in form of human readable language based on the corresponding insight dimension of the data record; and transmitting, for each of the L data records, the insight data to be presented to a user together with the respective combination of filters applied to generate the data record.

In various embodiments, a non-transitory computer readable medium having instructions stored thereon is disclosed. The instructions, when executed by at least one processor, cause at least one device to perform operations including: generating a plurality of data records based on a dataset, wherein each of the plurality of data records is generated by applying a respective combination of filters on the dataset; determining, for each of the plurality of data records, a corresponding one of N insight dimensions; selecting, among data records corresponding to each of the N insight dimensions, M data records to generate M*N data records, wherein M and N are integers larger than one; selecting, using a reinforcement learning model, L data records from the M*N data records, wherein L is an integer larger than one and less than M*N; determining, by applying a natural language model to each of the L data records, an insight data in form of human readable language based on the corresponding insight dimension of the data record; and transmitting, for each of the L data records, the insight data to be presented to a user together with the respective combination of filters applied to generate the data record.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to automatically generate and present insight data, in accordance with some embodiments of the present teaching.

FIG. 2 is a block diagram of an insight generation computing device, in accordance with some embodiments of the present teaching.

FIG. 3 is a block diagram illustrating various portions of an insight generation system, in accordance with some embodiments of the present teaching.

FIG. 4 illustrates an exemplary user interface displaying various insight data, in accordance with some embodiments of the present teaching.

FIG. 5 illustrates an exemplary user interface displaying detailed insight data in one insight dimension, in accordance with some embodiments of the present teaching.

FIG. 6 illustrates a process for generating insight data in form of natural language, in accordance with some embodiments of the present teaching.

FIG. 7 shows a block diagram illustrating various portions of an insight generation computing device, in accordance with some embodiments of the present teaching.

FIG. 8 illustrates a process for insight dimension determination and filter combination group selection, in accordance with some embodiments of the present teaching.

FIG. 9 illustrates a process for top group selection based on reinforcement learning, in accordance with some embodiments of the present teaching.

FIG. 10 illustrates a process for data linearization, in accordance with some embodiments of the present teaching.

FIG. 11 illustrates a process for generating insights based on a natural language generation model, in accordance with some embodiments of the present teaching.

FIG. 12 illustrates exemplary user interfaces displaying generated insight data, in accordance with some embodiments of the present teaching.

FIG. 13 illustrates a performance comparison between different sampling methods during reinforcement learning, in accordance with some embodiments of the present teaching.

FIG. 14 illustrates an exemplary architecture of a natural language generation model, in accordance with some embodiments of the present teaching.

FIG. 15 is a flowchart illustrating an exemplary method for automatically generating and presenting insight data, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Dashboards have multiple filter combinations that enable a user to focus on specific parts of data that may be of high importance. A framework is disclosed here to provide a one-stop solution by automatically identifying these filter combinations where the user might be interested in. In some embodiments, a system is disclosed to automatically shortlist the critical filter combinations using anomaly, trend and correlation detection methods to guide new users to the most crucial sections of data by providing interpretable insights, thereby increasing the turnaround time and boosting productivity.

One goal of various embodiments in the present teaching is to unearth hidden insights from data and provide these actionable insights in form of a guided approach to the related business. In some embodiments, a disclosed system may first create a shortlist of most important data groups based on anomaly, trend and correlation, where are three common and critical insight dimensions. For example, the system may use advanced anomaly detection techniques like isolation forests to determine anomaly groups, use change point detection algorithms to detect trend groups, and use statistical testing to ensure that the correlations are significant.

Further, to refine the shortlisted groups, the system may use a reinforcement learning algorithm based on the criticality of previously identified groups to choose the most relevant and critical groups to be highlighted to the business users. This may take into account the feedback received from users in the past and optimally select the best group, ensuring there is a healthy mix of past learnings and new unexplored groups.

The system may incorporate advanced natural language generation and table-to-text generation techniques to create the insights from the refined data, where the insights are in form of easy-to-understand natural language and would be actionable and easy to interpret. This can help artificial intelligence (AI) or be integrated into an AI system to make business reports more intelligent, actionable, and in form of guided approach, which will save time and effort for the entire business team.

In some embodiments, each insight data is to be displayed in a user interface (UI), e.g. as a card, specifying the filter combination used to derive the insight data. In addition, an experienced user may choose desired filter combinations. In response, insights will be generated in real-time based on the desired filter combinations for these users. Further, the UI may include an option for a user to provide feedback on whether the insight was helpful, which will aid in improving the disclosed framework to understand the users' needs. The disclosed system and method can make business reports more intelligent, actionable, and in form of guided approach, which will save money, save end-users time, save onboarding time and build new capabilities. The disclosed system and method may be applicable to any scenario where data insights are desired to interpret the data, understand the data, and/or perform any other actions based on the data insights.

Furthermore, in the following, various embodiments are described with respect to methods and systems for automatically generating and presenting insight data in form of natural language are disclosed. In some embodiments, each of a plurality of data records is generated by applying a respective combination of filters on a dataset. For each data record, a corresponding one of N insight dimensions is determined. M data records are selected among data records corresponding to each insight dimension, to generate M*N data records. Using a reinforcement learning model, L data records are selected from the M*N data records. By applying a natural language model to each of the L data records, an insight data is generated in form of human readable language based on the corresponding insight dimension of the data record, and presented to a user together with the respective combination of filters applied to generate the data record.

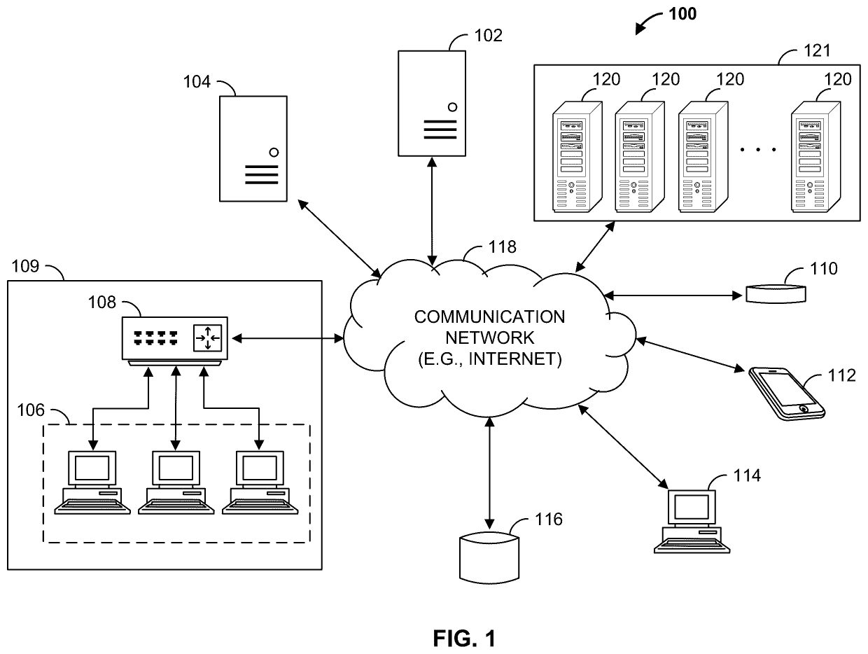

Turning to the drawings, FIG. 1 is a network environment 100 configured to automatically generate and present insight data, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an insight generation computing device 102 (e.g., a server, such as an application server), a web server 104, a cloud-based engine 121 including one or more processing devices 120, workstation(s) 106, a database 116, and one or more customer computing devices 110, 112, 114 operatively coupled over the network 118. The insight generation computing device 102, the web server 104, the workstation(s) 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the insight generation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the insight generation computing device 102.

In some examples, each of the multiple customer computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more websites providing one or more products or services. In some examples, the insight generation computing device 102, the processing devices 120, and/or the web server 104 are operated by a retailer, and the multiple customer computing devices 110, 112, 114 are operated by customers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109, for example. The workstation(s) 106 can communicate with the insight generation computing device 102 over the communication network 118. The workstation(s) 106 may send data to, and receive data from, the insight generation computing device 102. For example, the workstation(s) 106 may transmit data identifying items purchased by a customer at the store 109 to insight generation computing device 102.

Although FIG. 1 illustrates three customer computing devices 110, 112, 114, the network environment 100 can include any number of customer computing devices 110, 112, 114. Similarly, the network environment 100 can include any number of the insight generation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the first customer computing device 110, the second customer computing device 112, and the Nth customer computing device 114 may communicate with the web server 104 over the communication network 118. For example, each of the multiple computing devices 110, 112, 114 may be operable to view, access, and interact with a website, such as a retailer's website, hosted by the web server 104. The web server 104 may transmit user session data related to a customer's activity (e.g., interactions) on the website. For example, a customer may operate one of the customer computing devices 110, 112, 114 to initiate a web browser that is directed to the website hosted by the web server 104. The customer may, via the web browser, view item advertisements for items displayed on the website, and may click on item advertisements, for example. The website may capture these activities as user session data, and transmit the user session data to the insight generation computing device 102 over the communication network 118. The website may also allow the operator to add one or more of the items to an online shopping cart, and allow the customer to perform a “checkout” of the shopping cart to purchase the items. In some examples, the web server 104 transmits purchase data identifying items the customer has purchased from the website to the insight generation computing device 102.

In some examples, the insight generation computing device 102 may execute one or more models (e.g., algorithms), such as a machine learning model, deep learning model, statistical model, etc., to determine recommended items to advertise to the customer (i.e., item recommendations). The insight generation computing device 102 may transmit insight data (e.g. insights about customer behaviors, advertisement data, etc.) to the web server 104 over the communication network 118, and the web server 104 may display the insight data on the website to users (e.g. merchants and suppliers) who are interested in these data.

In some examples, the web server 104 transmits an insight generation request to the insight generation computing device 102. The insight generation request may be sent together with a selection of one or more filters provided by a user (e.g., via a dashboard user interface), or a standalone insight generation request provided by a processing unit in response to the user's action on a website, e.g. clicking a button on the website, submitting a request on the website.

In one example, a merchant or supplier is interested in online shoppers' behavior and submits a request on a website hosted by the web server 104, e.g. by clicking on a button indicating a request for insights of online shoppers' behavior. The web server 104 may then send an insight generation request to the insight generation computing device 102. In response to receiving the insight generation request, the insight generation computing device 102 may execute the one or more processors to generate insight data by automatically and smartly applying filters on online shoppers' behavior data. The insight generation computing device 102 may transmit some or all of the insight data to the web server 104 to be displayed together with the smart filters applied to the merchant or supplier.

In another example, a seller or advertiser is interested in historical advertisement data of one or more items, and submits a search query on a website hosted by the web server 104, e.g. by entering a query in a search bar. The web server 104 may send an insight generation request to the insight generation computing device 102. In response to receiving the insight generation request, the insight generation computing device 102 may execute the one or more processors to first determine search results including advertisement data matching the search query, and then generate insight data by automatically and smartly applying filters on advertisement data. The insight generation computing device 102 may transmit some or all of the insight data to the web server 104 to be displayed together with the smart filters applied and the search results to the seller or advertiser.

The insight generation computing device 102 is further operable to communicate with the database 116 over the communication network 118. For example, the insight generation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the insight generation computing device 102, in some examples, the database 116 can be a local storage device, such as a hard drive, a non-volatile memory, or a USB stick. The insight generation computing device 102 may store purchase data received from the web server 104 in the database 116. The insight generation computing device 102 may also receive from the web server 104 user session data identifying events associated with browsing sessions, and may store the user session data in the database 116.

In some examples, the insight generation computing device 102 generates training data for a plurality of models (e.g., machine learning models, deep learning models, statistical models, algorithms, etc.) based on: e.g. historical customer session data, search data, purchase data, catalog data, advertisement data, shopping analysis data, chatbot data, waste data, etc. The insight generation computing device 102 trains the models based on their corresponding training data, and the insight generation computing device 102 stores the models in a database, such as in the database 116 (e.g., a cloud storage).

The models, when executed by the insight generation computing device 102, allow the insight generation computing device 102 to generate insight data based on corresponding datasets. For example, the insight generation computing device 102 may obtain the models from the database 116. The insight generation computing device 102 may then receive, in real-time from the web server 104, an insight generation request identifying a request by a user for insights of online chatbot data by a user. In response to receiving the request, the insight generation computing device 102 may execute the models to generate insights for the online chatbot data to be displayed to the user.

In some examples, the insight generation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the insight generation computing device 102 may generate insight data to be displayed on the website to a user. In some examples, the insight data may be displayed in form of human readable language in user interface components, e.g. cards.

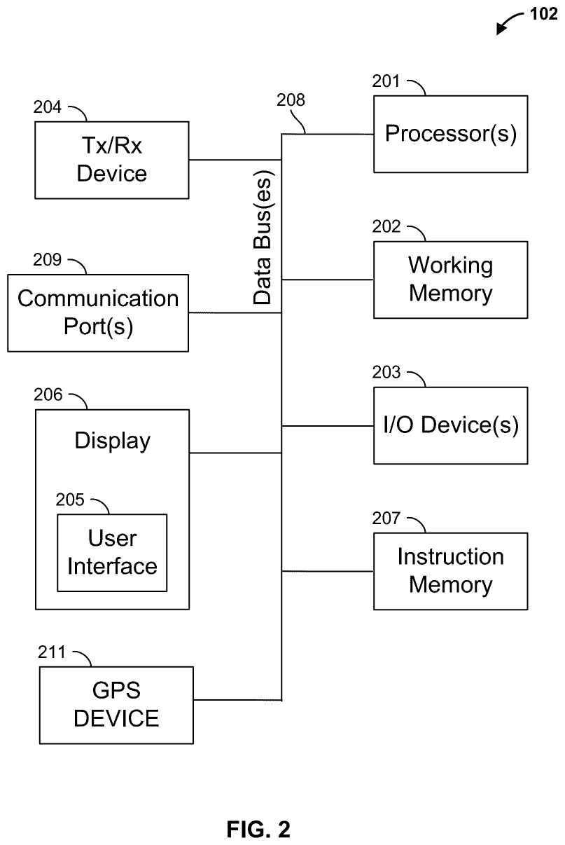

FIG. 2 illustrates a block diagram of an insight generation computing device, e.g. the insight generation computing device 102 of FIG. 1, in accordance with some embodiments of the present teaching. In some embodiments, each of the insight generation computing device 102, the web server 104, the workstation(s) 106, the multiple customer computing devices 110, 112, 114, and the one or more processing devices 120 in FIG. 1 may include the features shown in FIG. 2. Although FIG. 2 is described with respect to the insight generation computing device 102. It should be appreciated, however, that the elements described can be included, as applicable, in any of the insight generation computing device 102, the web server 104, the workstation(s) 106, the multiple customer computing devices 110, 112, 114, and the one or more processing devices 120.

As shown in FIG. 2, the insight generation computing device 102 can include one or more processors 201, a working memory 202, one or more input/output devices 203, an instruction memory 207, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the insight generation computing device 102. The working memory 202 can be a random access memory (RAM) such as a static random access memory (SRAM) or dynamic random access memory (DRAM), or any other suitable memory.

The input-output devices 203 can include any suitable device that allows for data input or output. For example, the input-output devices 203 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the insight generation computing device 102. For example, the user interface 205 can be a user interface for an application of a retailer that allows a customer to view and interact with a retailer's website. In some examples, a user can interact with the user interface 205 by engaging the input-output devices 203. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the insight generation computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the insight generation computing device 102 may determine a local geographical area (e.g., town, city, state, etc.) of its position. Based on the geographical area, the insight generation computing device 102 may determine relevant trend data (e.g., trend data identifying events in the geographical area).

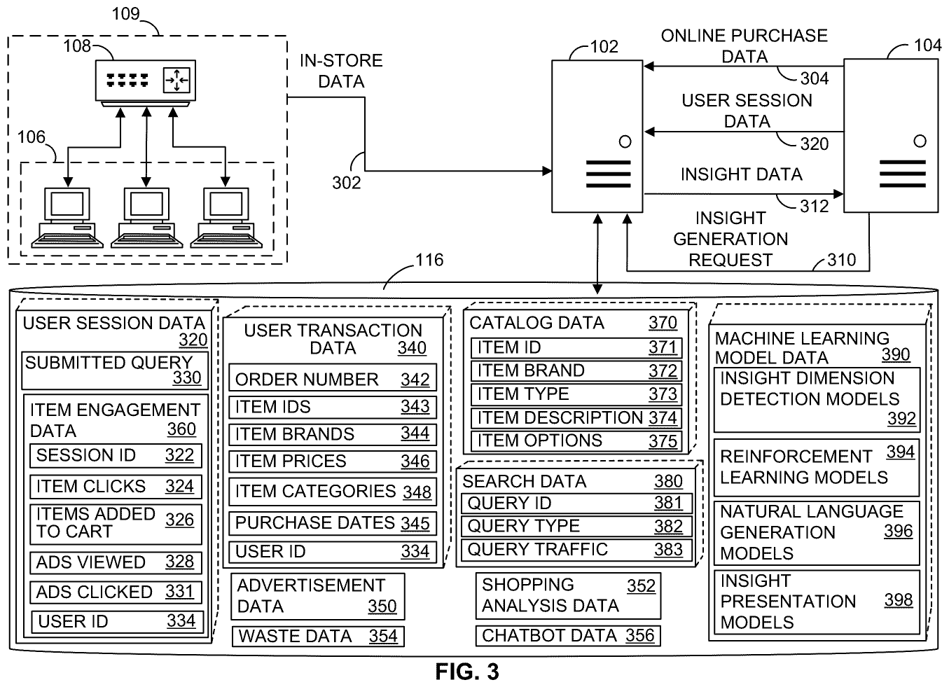

FIG. 3 is a block diagram illustrating various portions of an insight generation system, e.g. the insight generation system shown in the network environment 100 of FIG. 1, in accordance with some embodiments of the present teaching. As indicated in FIG. 3, the insight generation computing device 102 may receive user session data 320 from the web server 104, and store the user session data 320 in the database 116. The user session data 320 may identify, for each user (e.g., customer), data related to that user's browsing session, such as when browsing a retailer's webpage hosted by the web server 104.

In some examples, the user session data 320 may include item engagement data 360 and/or submitted query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.). The submitted query data 330 may identify one or more searches conducted by a user during a browsing session (e.g., a current browsing session).

The insight generation computing device 102 may also receive online purchase data 304 from the web server 104, which identifies and characterizes one or more online purchases, such as purchases made by the user and other users via a retailer's website hosted by the web server 104. The insight generation computing device 102 may also receive in-store data 302 from the store 109, which identifies and characterizes one or more in-store purchases, in-store advertisements, in-store shopping data, etc. In some embodiments, the in-store data 302 may also indicate availability of items in the store 109, and/or user IDs that have selected the store 109 as a default store for picking up online orders.

The insight generation computing device 102 may parse the in-store data 302 and the online purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item categories 348 identifying a category of each item purchased, a purchase date 345 identifying the purchase date of the purchase order, and user ID 334 for the user making the corresponding purchase.

The database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., a product type like grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store search data 380, which may identify one or more attributes of a plurality of queries submitted by users on the website. The search data 380 may include, for each of the plurality of queries, a query ID 381 identifying a query previously submitted by users, a query type 382 (e.g., a head query, a torso query, or a tail query), and query traffic data 383 identifying how many times the query has been submitted or how many clicks the query has received.

The database 116 may also store advertisement data 350, which may identify one or more attributes of a plurality of advertisements for sponsored items on the website. The advertisement data 350 may include, for each of the plurality of advertisements, campaign data identifying data of an advertising campaign for the advertisement, auction data identifying auction information for the advertisement (e.g. default bidding price, a bidding scheme for the advertisement, historical auction results for the advertisement, etc.), sponsored item(s) associated with the advertisement, an advertisement ID identifying the advertisement, and/or ad tag data identifying ad tags associated with the advertisement.

The database 116 may also store shopping analysis data 352, which may identify one or more attributes of shopping data collected from the web server 104 and the store 109. The shopping analysis data 352 may include: shopper behavior data identifying behaviors of shoppers online or in-store, customer perception data identifying precepted information of customers online or in-store, and/or channel performance data identifying performances of different channels for selling items, e.g. online, in-store, or via a third party.

The database 116 may also store waste data 354 identifying data about waste produced by different items at different stores; and chatbot data 356 identifying data about conversations performed between online users and one or more chatbots associated with the web server 104.

The database 116 may also store machine learning model data 390 identifying and characterizing one or more machine learning models and related data for generating and presenting insight data. For example, the machine learning model data 390 may include insight dimension detection models 392, one or more reinforcement learning models 394, one or more natural language generation models 396, and one or more insight presentation models 398.

In some embodiments, each insight dimension detection model 392 may be used to detect a corresponding insight dimension from data records. A data record generated by a filter combination (i.e. a combination of filters) may have different insight dimensions, e.g. anomaly, trends, correlation, etc. For example, the insight dimension detection models 392 may include: an isolation forest model used to detect anomaly type data records; a change point detection model used to detect trend type data records; and a t-test model used to detect correlation type data records.

The one or more reinforcement learning models 394 may be used to select top data records from data records detected with insight dimensions, e.g. based on a sampling from fitted Beta distributions. In some embodiments, the reinforcement learning model 394 is trained based on rewards generated from previous user feedbacks. The state of the reinforcement learning model 394, including parameters of the fitted Beta distributions, may be dynamically updated based on users' feedback to balance between exploit and explore.

The one or more natural language generation models 396 may be used to generate insight data in form of human readable language. In some embodiments, the selected top data records may be linearized using certain tags. For each linearized data record, the natural language generation model 396 may be applied to produce interpretable insights in human readable form like natural language, e.g. based on the corresponding insight dimension of the data record.

The one or more insight presentation models 398 may be used to determine a presentation style for the generated insight data. The one or more insight presentation models 398 may indicate: a type of user interface for displaying the insight data, content to be displayed together with the insight data in the user interface, layout of different content in the user interface, etc.

In some examples, the insight generation computing device 102 receives (e.g., in real-time) an insight generation request 310 from the web server 104. In response, the insight generation computing device 102 generates insight data 312 identifying insights of data concerned by a user, and transmits the insight data 312 to the web server 104. In some examples, the insight generation request 310 may be associated with a dataset interested by a user of a website hosted by the web server 104. In response, the insight generation computing device 102 generates the insight data 312 identifying insights of the dataset that can help the user to interpret the dataset, understand the dataset, or make actions based on the dataset. In some embodiments, the website may be a different website from the retailer's online shopping website. In some embodiments, the website may or may not be related to the retailer's online shopping website. In some embodiments, the user may be a merchant, a supplier, a seller, a customer, a business manager, or any other user desiring insights of data collected by the web server 104.

In some embodiments, the insight generation computing device 102 may assign one or more of the above described operations to a different processing unit or virtual machine hosted by the one or more processing devices 120. Further, the insight generation computing device 102 may obtain the outputs of the these assigned operations from the processing units, and generate the insight data 312 based on the outputs.

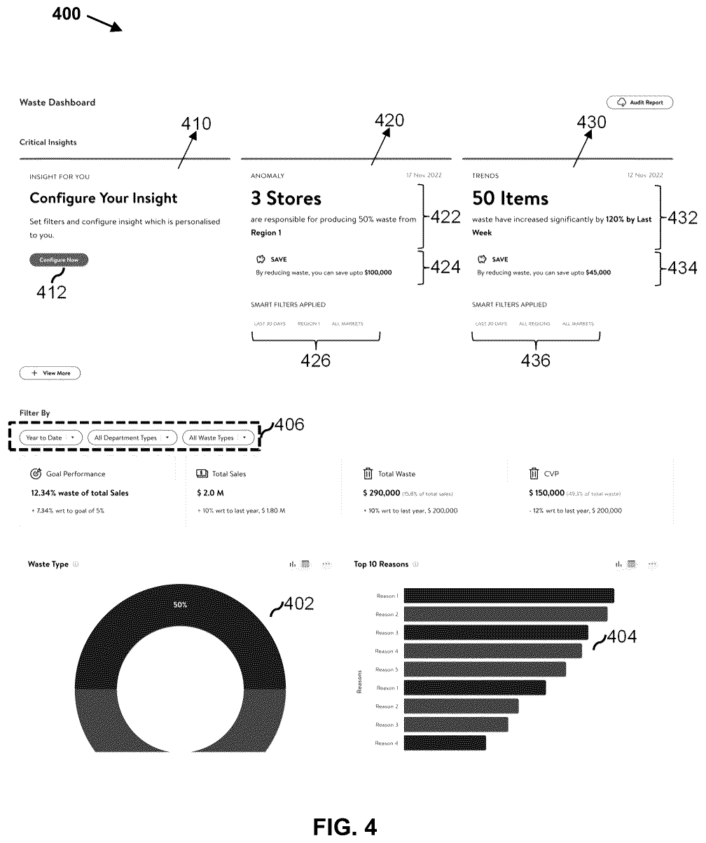

FIG. 4 illustrates an exemplary user interface 400 displaying various insight data, in accordance with some embodiments of the present teaching. In some embodiments, the user interface 400 is on a website or APP hosted by, for example, the web server 104, and may display insight data 312 generated by the insight generation computing device 102 in response to the insight generation request 310 with respect to a dataset.

In the example shown in FIG. 4, the web server 104 presents a waste dashboard via the user interface 400. The waste dashboard is used to provide waste data about wastes generated by sales of different items at different stores of a retailer. As shown in FIG. 4, the user interface 400 shows: a chart 402 illustrating different waste types of the entire dataset, and a chart 404 illustrating different reasons of waste generations of the entire dataset. But a user is often interested in a specific subset of the dataset, and the specific subset can only be generated by applying a specific combination of filters, which the user might not be aware of. For example, while the user interface 400 provides a plurality of filters 406 for the user to filter the dataset, it may cost lots of time and efforts for the user to click on each filter to set it for different values, to find a suitable combination of filters to generate an interesting data subset. In addition, when presenting the interesting data subset, a chart is still more difficult to understand compared to plain natural language.

As shown in FIG. 4, the waste dashboard in this example also includes a critical insights section comprising a plurality of cards 410, 420, 430. The card 420 is a user interface component showing an anomaly type insight generated from the waste dataset. The card 420 includes a summary section 422 showing the anomaly type insight with a natural language: “3 Stores are responsible for producing 50% waste from Region 1.” This provides an interpretable insight of the waste dataset for the user to easily understand an anomaly in the waste dataset. The card 420 also includes a deduction section 424 showing a deduction from the anomaly type insight with a natural language: “By reducing waste, you can save up to $100,000.” This provides an actionable insight of the waste dataset to help the user to decide on what to do based on the detected anomaly. In addition, the card 420 also includes a filter combination section 426 showing a specific combination of filters automatically used to generate the data subset corresponding to the anomaly type insight. In this example, the specific combination of filters in the filter combination section 426 include: a time filter used to select the last 30 days, a region filter used to select Region 1, and a market filter used to select all markets.

As shown in FIG. 4, the card 430 is a user interface component showing a trend type insight generated from the waste dataset. The card 430 includes a summary section 432 showing the trend type insight with a natural language: “50 Items waste have increased significantly by 120% by Last Week.” This provides an interpretable insight of the waste dataset for the user to easily understand the trend in the waste dataset. The card 430 also includes a deduction section 434 showing a deduction from the trend type insight with a natural language: “By reducing waste, you can save up to $45,000.” This provides an actionable insight of the waste dataset to help the user to decide on what to do based on the detected trend. In addition, the card 430 also includes a filter combination section 436 showing a specific combination of filters automatically used to generate the data subset corresponding to the trend type insight. In this example, the specific combination of filters in the filter combination section 436 include: a time filter used to select the last 30 days, a region filter used to select All Regions, and a market filter used to select all markets.

As shown in FIG. 4, the card 410 is a user interface component showing an option for a user to configure own personalized insight. The card 410 includes a button “Configure Now” 412, which once clicked by a user, can provide the user various filters and parameters to configure its own combination of filters, to generate one or more insights personalized to the user, in form of natural language. The insights in cards 420, 430 are automatically generated based on machine learning models trained based on previous user feedback data, and are suitable to most users. But sometimes a user may still want to configure a personalized insight in addition to the automatically generated insights. In some embodiments, a personally configured insight may be used as a starting point to train a new model or update an existing model to automatically generate future insights.

In some embodiments, the user interfaces may include less than or more than two insight cards. In some embodiments, the user interfaces may include less than or more than two types of insights. In some embodiments, once a user clicks on an automatically generated insight card, e.g. card 420 or card 430, another user interface will be displayed to the user to show details about the corresponding insight.

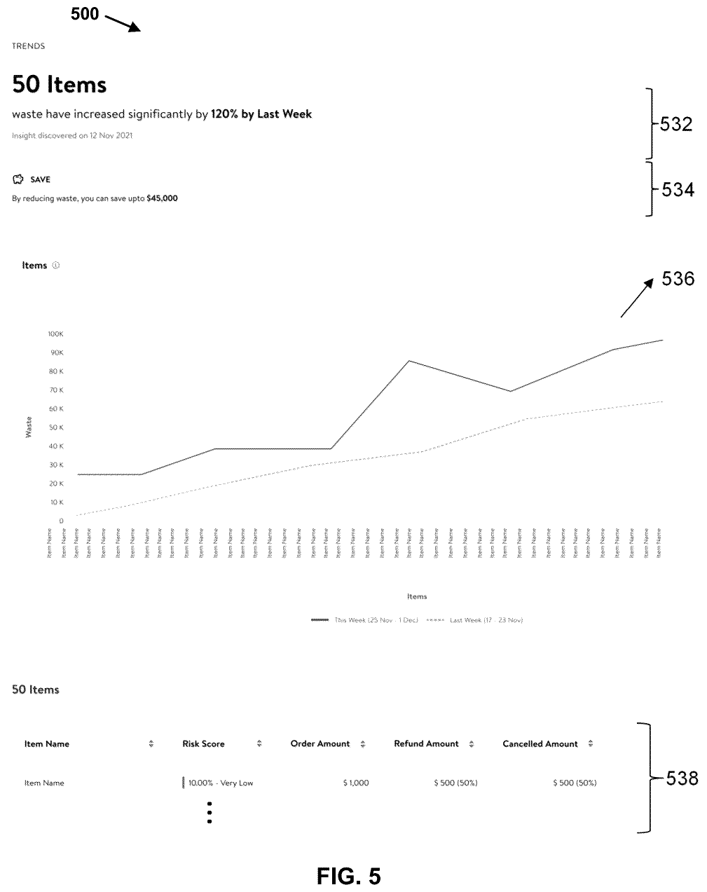

FIG. 5 illustrates an exemplary user interface 500 displaying detailed insight data in one insight dimension, in accordance with some embodiments of the present teaching. In some embodiments, once a user clicks on the insight card 430 in FIG. 4, the user interface 500 may be displayed to the user to present drill down details of the trend insight.

As shown in FIG. 5, the user interface 500 includes a summary section 532 showing the trend type insight like the summary section 432 in FIG. 4; and a deduction section 534 showing a deduction from the trend type insight like the deduction section 434 in FIG. 4. In addition, the user interface 500 includes a chart 536 showing the waste trend corresponding to the trend type insight. Further, the user interface 500 also includes a table 538 listing the 50 items having the trend type insight. That is, the user interface 500 provides supporting data to show the detailed result, resource and contributing elements of the trend type insight.

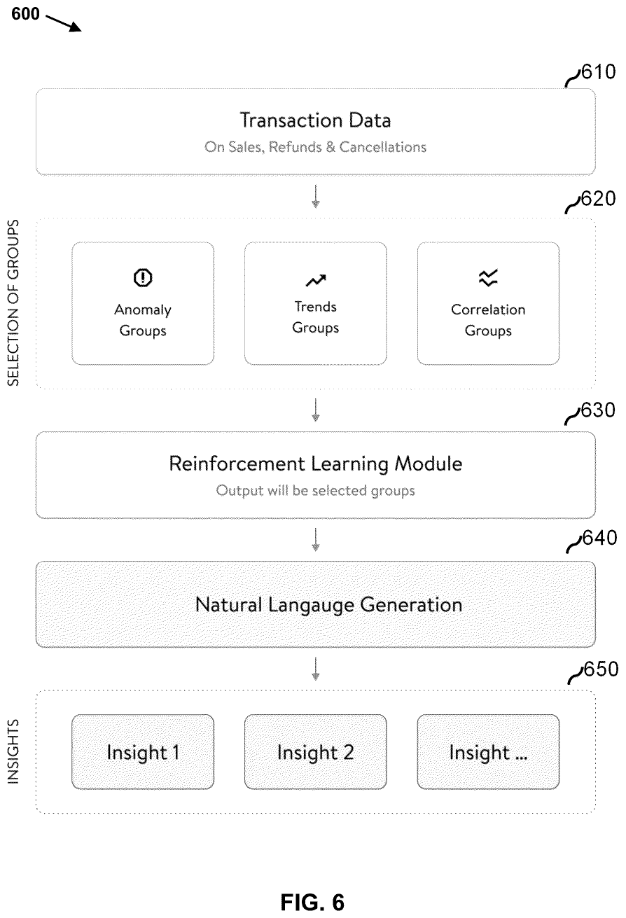

In some embodiments, business dashboards make use of structured tabular data to display various charts and illustrations, where every possible filter combination is present as a separate record. One objective of a disclosed system is to identify these specific filter combinations that contain potentially critical business information and present them as human readable insights to the end users, enabling a guided workflow. In some embodiments, a solution framework may comprise three major components: selection of groups, reinforcement learning module, and natural language generation, as shown in FIG. 6.

FIG. 6 illustrates a process 600 for generating insight data in form of natural language, in accordance with some embodiments of the present teaching. In some embodiments, the process 600 may be carried out by one or more computing devices, such as the insight generation computing device 102 and/or the cloud-based engine 121 of FIG. 1. As shown in FIG. 6, the process 600 starts from operation 610, where transaction data is obtained. For example, the insight generation computing device 102 may receive the transaction data from the web server 104 together with an insight generation request, or may retrieve the transaction data from the database 116 upon receiving the insight generation request from the web server 104. While transaction data is used here in FIG. 6 as an example, it can be understood that the process 600 may be applied to other types of data similarly in other embodiments.

At operation 620, different filter combination groups are selected for different insight dimensions. In this example, the different insight dimensions include: anomaly, trends, correlation. Each filter combination group may be determined to correspond to one of the three insight dimensions, e.g. based on a respective one of the insight dimension detection models 392 stored in the database 116. In some embodiments, there are less than or more than three insight dimensions. In some embodiments, there may be a new insight dimension generated by the system based on user feedback, user inputs, and/or a machine learning process.

At operation 630, a reinforcement learning model is utilized to select a subset of the filter combination groups output by the selection of groups at the operation 620. The subset is selected to maximize a likelihood to match users' interest, based on the reinforcement learning model that is trained using previous users' feedbacks. The reinforcement learning model may be one of the reinforcement learning models 394 stored in the database 116.

At operation 640, an insight is generated for each data record (corresponding to a respective filter combination group) in the selected subset, based on a natural language generation model, which may be one of the natural language generation models 396 stored in the database 116. The insight generated at the operation 640 is in form of a natural language such that it is easy for a user to directly read and understand. In some embodiments, semantics of the insights generated at the operation 640 may vary according to the dimension determined for the filter combination. For example, a semantic for an anomaly type insight may be different from a semantic for a correlation type insight. At operation 650, one or more insights generated by the natural language generation model may be presented to users, e.g. via a user interface as shown in FIG. 4.

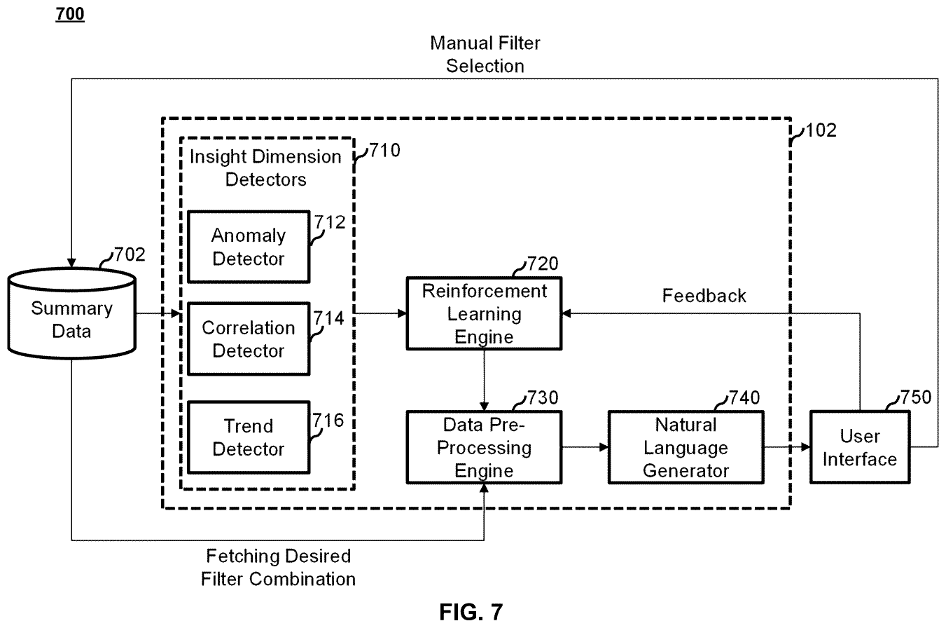

FIG. 7 shows a block diagram of an insight generation system 700 illustrating various portions of an insight generation computing device, e.g. the insight generation computing device 102 in FIG. 1, in accordance with some embodiments of the present teaching. As shown in FIG. 7, the insight generation computing device 102 includes insight dimension detectors 710, a reinforcement learning engine 720, a data pre-processing engine 730, and a natural language generator 740. In some examples, one or more of the insight dimension detectors 710, the reinforcement learning engine 720, the data pre-processing engine 730, and the natural language generator 740 are implemented in hardware. In some examples, one or more of the insight dimension detectors 710, the reinforcement learning engine 720, the data pre-processing engine 730, and the natural language generator 740 are implemented as an executable program maintained in a tangible, non-transitory memory, such as instruction memory 207 of FIG. 2, which may be executed by one or more processors, such as the processor 201 of FIG. 2.

For example, the insight dimension detectors 710 may obtain, from a summary database 702, a plurality of data records generated based on a dataset. This may be triggered by an insight generation request 310 received from the web server 104. The summary database 702 may be part of the database 116 or a standalone database. In some embodiments, each of the plurality of data records is generated by applying a respective combination of filters on the dataset. For example, the insight generation computing device 102 may have previously applied all possible combinations of filters on the dataset to generate the plurality of data records, and store the plurality of data records in the summary database 702. In other examples, the insight generation computing device 102 may generate the plurality of data records after receiving the insight generation request 310 from the web server 104. In some embodiments, the plurality of data records form a summary table.

In some embodiments, a corresponding one of N insight dimensions is determined for each of the plurality of data records. In the example shown in FIG. 7, the insight dimension detectors 710 may determine, for each data record retrieved from the summary database 702, one of three insight dimensions: anomaly, correlation, trend. As shown in FIG. 7, the insight dimension detectors 710 includes: an anomaly detector 712, a correlation detector 714, and a trend detector 716.

In some embodiments, for each data record, the anomaly detector 712 can determine whether this data record indicates an anomaly type insight. In some embodiments, the anomaly detection may be performed based on an isolation forest algorithm using features like various measures of central tendency and spread of various transaction features, in the example of a transaction dataset. The isolation forest algorithm is a multivariate outlier detection technique. In some embodiments, the isolation forest algorithm may be used to identify top 5 data records indicating anomaly type insight, i.e. top 5 anomalous filter combination groups.

In some embodiments, for each data record, the correlation detector 714 can determine whether this data record indicates a correlation type insight. In some embodiments, the correlation detection may be performed based on a t-test model to find top 5 filter combination groups having significant Spearman's rank correlation across certain pair of features.

In some embodiments, for each data record, the trend detector 716 can determine whether this data record indicates a trend type insight. In some embodiments, the trend detection may be performed based on a change point detection model including a pruned exact linear time (PELT) algorithm, to find top 5 filter combination groups having significantly high month over month percentage change in a feature of interest.

The anomaly detector 712, the correlation detector 714 and the trend detector 716 may operate in parallel or in serial. In some embodiments, all possible filter combination groups are considered for a given view, to select, among data records corresponding to each of the N insight dimensions, M data records to generate M*N data records, wherein M and N are integers larger than one. In the examples described above, N=3 representing 3 insight dimensions (anomaly, trend, correlation); M=5 representing 5 filter combinations selected for each of the 3 dimensions.

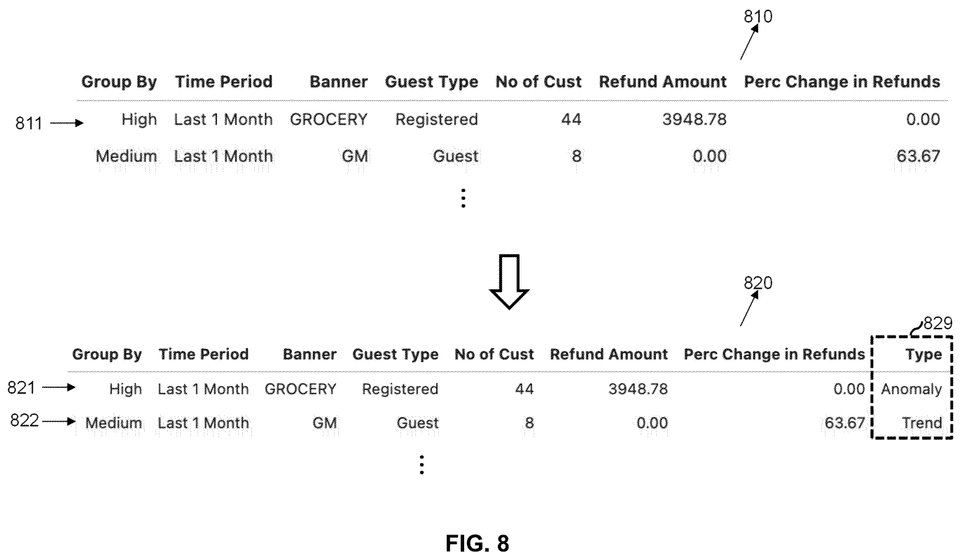

FIG. 8 illustrates a process for insight dimension determination and filter combination group selection, in accordance with some embodiments of the present teaching. As shown in FIG. 8, a summary table 810 includes a plurality of data records. In this example, the plurality of data records are related to refund or chargeback during transactions. As mentioned above, each data record is generated by applying a corresponding filter combination on a same entire dataset, which is related to transaction refund in this example. In some embodiments, all possible filter combinations are considered to generate the data records in the summary table 810. As such, each data record corresponds to a given filter combination group, and is generated by aggregating all data points falling under this filter combination group. For example, the data record 811 corresponds to a time period filter set to be last one month, a banner filter set to be grocery, a guest type set to be registered, etc.

As shown in FIG. 8, for each filter combination group, corresponding significant dimension is determined, whether it is anomaly, trend or correlation. In the example shown in FIG. 8, the summary table 810 is updated to be a summary table 820, by adding a column of insight type 829, indicating a type of insight detected from each data record. For example, for data record 821, a corresponding significant dimension is determined to be anomaly, e.g. based on an isolation forest model in view of the abnormal refund amount (about 3949) of the data record 821 compared to other data records. In another example, for data record 822, a corresponding significant dimension is determined to be trend, e.g. based on a change point detection model in view of its significant and extraordinary high percent change (about 64%) in refunds during last month. In some embodiments, an anomaly is detected for a data record based on a comparison of its feature with the same feature of other data records (during a same time period), to identify anomalous data records or outliers. In some embodiments, a trend is detected for a data record based on a comparison of its feature at a current time period with the same feature at a previous time period, to identify continuous change of behavior in time. In some embodiments, a correlation may be detected for a data record based on a comparison of its various features, where the data record may include a plurality of data points aggregated by the corresponding filter combination to reflect the correlation, to identify a data record including features that are highly correlated in a same time period.

In the examples described above, top 5 combinations are shortlisted from each of the 3 dimensions, and sent to the reinforcement learning engine 720 for reinforcement learning. For example, for the anomaly dimension, top 5 combinations with highest amount of refund are selected. Similarly for the trend dimension, top 5 combinations with highest percentage change from previous month are selected. In general, the insight dimension detectors 710 may select M data records for each of N insight dimensions, to generate and send M*N data records to the reinforcement learning engine 720 for reinforcement learning. M and N are integers larger than one.

In some embodiments, multiple insight dimensions may be detected for one single data record. In some examples, all of the multiple insight dimensions may be retained for reinforcement learning by the reinforcement learning engine 720. In some examples, only one of the multiple insight dimensions is selected for the data record, to be sent to the reinforcement learning engine 720. For example, each of the anomaly detector 712, the correlation detector 714 and the trend detector 716 may determine an insight score associated with a respective insight dimension for a same data record, based on corresponding models respectively. An insight dimension having the highest insight score may be determined for the same data record.

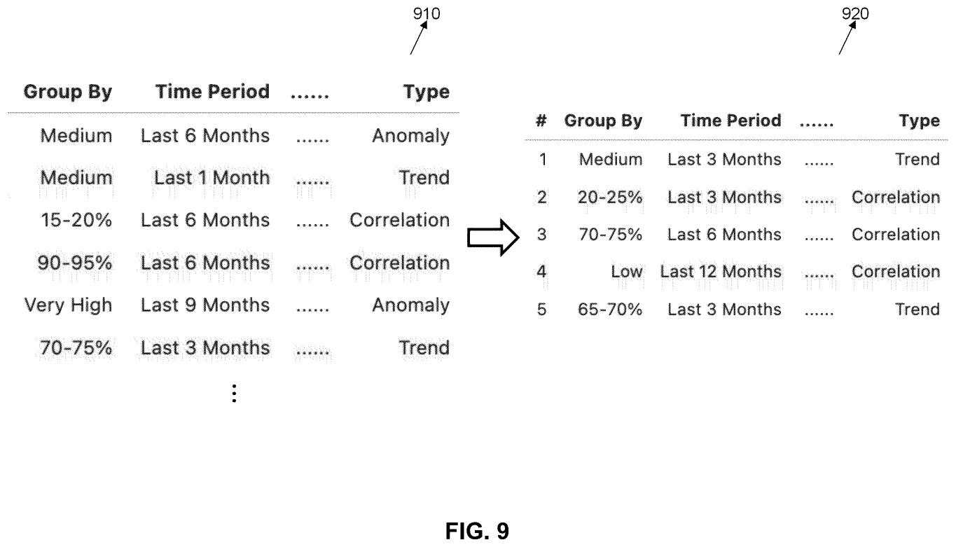

In some embodiments, the reinforcement learning engine 720 selects, using a reinforcement learning model, L data records from the M*N data records, wherein L is an integer larger than one and less than M*N. FIG. 9 illustrates a process for top group selection based on reinforcement learning, in accordance with some embodiments of the present teaching. As shown in FIG. 9, the summary table 910 is obtained based on the 15 (3*5) filter combination groups generated from the summary table 820 shown in FIG. 8. The summary table 910 is updated by the reinforcement learning engine 720 to be a summary table 920, by selecting the final top 5 filter combination groups based on the reinforcement learning model. That is, L=5 in the example shown in FIG. 9. In some embodiments, the reinforcement learning model is trained based on past user feedback. In some embodiments, state of the system (including the reinforcement learning model) gets constantly updated based on users' preference and feedback with respect to presented insights.

In some embodiments, to select the final top 5 filter combination groups, the reinforcement learning engine 720 may define a reward as a proportion of cases leading to a true risk feedback from end users over a past time period, e.g. past 4 weeks, withing each dimension set (3 in total) including 5 combinations. In some embodiments, the reward is determined based on likes and dislikes in users' previous feedbacks. The reinforcement learning engine 720 selects the top 5 filter combination groups that have the highest likelihood of success conversion, meaning the users will give a maximum proportion of likes.

In some embodiments, the reinforcement learning engine 720 may utilize a concurrent arm Beta sampling technique to select the final top 5 filter combination groups among the 15 groups. For each of the 15 groups, the reinforcement learning engine 720 chooses a probability of selection from a corresponding fitted Beta distribution. In some embodiments, the final selected groups will have a combination of exploit and explore groups, corresponding to the top 5 probabilities of selection. The reinforcement learning engine 720 may send the final top 5 filter combination groups to the data pre-processing engine 730 for data pre-processing.

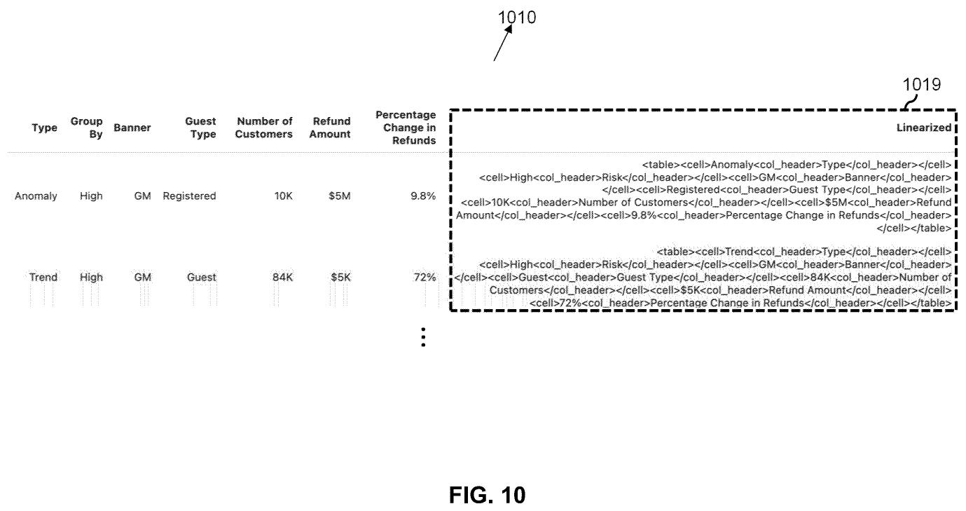

In some embodiments, the data pre-processing engine 730 obtains the final top 5 filter combination groups from the reinforcement learning engine 720, and performs a linearization on each of the final top 5 filter combination groups. FIG. 10 illustrates a process for data linearization, in accordance with some embodiments of the present teaching. As shown in FIG. 10, a summary table 1010 is generated by adding a column 1019 to include a linearized version of each data record, corresponding to each of the 5 filter combination groups. As shown in FIG. 10, the tabular data is linearized using certain tags to identify each record's cell value and its corresponding attribute. These tags can help the system to understand the contents in a table record. The data pre-processing engine 730 may send the linearized data records to the natural language generator 740 for natural language generation.

In some embodiments, the natural language generator 740 can generate an insight data for each of the final top 5 filter combination groups, or in general each of the L data records. For example, the natural language generator 740 may apply a natural language generation model to each linearized data record to generate an insight in form of human readable language based on the corresponding insight dimension of the data record.

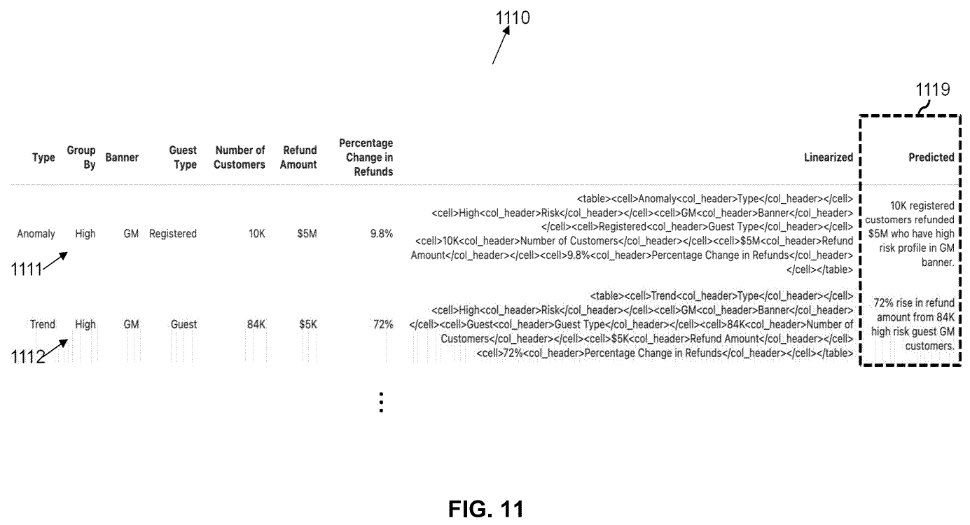

FIG. 11 illustrates a process for generating insights based on a natural language generation model, in accordance with some embodiments of the present teaching. As shown in FIG. 11, a summary table 1110 is generated by adding a column 1119 to include a predicted natural language insight for each data record, corresponding to each of the 5 filter combination groups. As shown in FIG. 11, the data record 1111 is predicted to have a natural language insight of “10K registered customers refunded $5M who have high risk profile in GM banner,” to indicate an anomaly. In addition, the data record 1112 is predicted to have a natural language insight of “72% rise in refund amount from 84K high risk guest GM customers,” to indicate a trend.

In some embodiments, the natural language generation model produces interpretable insights in human readable form based on the record's contents. Semantics of the generated insights may vary according to the dimensions determined for different filter combination groups.

In some embodiments, the natural language generation model may be generated based on a T5 transformer model for conditional generation, and is specifically fine-tuned for table-to-text generation. The tabular data is linearized using certain tags to identify a record's cell value and its corresponding attribute. These tags are added as special tokens to the model, for pre-processing the inputs to the model.

In some embodiments, the training corpus of the natural language generation model may comprise many (e.g. 150K) reference sentences that was automatically generated using several templates of various kinds, for each of the three dimensions to ensure the natural language generation model learns a wide spectrum of semantics, like the ordering of words and other sentence structuring. In some embodiments, the natural language generation model is trained on an equal number of insights (e.g. 50K) for each insight dimension: anomaly, trend and correlation, to generalize the insight generation in future.

Referring back to FIG. 7, in some embodiments, the natural language generator 740 can transmit the insight data generated for each data record to a user interface 750, which displays the insight data to a user together with the respective combination of filters applied to generate the data record at the beginning. In some embodiments, the natural language generator 740 can transmit the insight data to the web server 104, which will display the insight data on the user interface 750, e.g. via a website or APP hosted by the web server 104.

In some embodiments, a same set of insight data generated from a same dataset (e.g. a transaction dataset, a refund dataset, a waste dataset, a chatbot dataset, an advertisement dataset, a shopping analysis dataset, etc.) may be presented to a plurality of users who are interested in the dataset. As shown in FIG. 7, the user interface 750 may receive feedback data from the plurality of users, and send the feedback data back to the reinforcement learning engine 720 to update the state of the system, e.g. updating one or more hyperparameters of the reinforcement learning model. For example, based on the proportion of likes and dislikes, the reinforcement learning engine 720 can update the hyperparameters of the reinforcement learning model, to provide more meaningful and impactful insights.

As discussed above, a user, e.g. an experienced user who is very familiar with a dataset, may submit a request to configure a personalized set of filters to be applied to the dataset. In this case, the user interface 750 may receive a manual filter selection from the user, and send the manual filter selection to the summary database 702 to retrieve or fetch a desired filter combination to the data pre-processing engine 730. That is, the filter combination personalized for the user is directly linearized by the data pre-processing engine 730 to generate a natural language insight based on the natural language generation model at the natural language generator 740. As such, the natural language insight can be presented to the user via the user interface 750 in real-time after the user submitting the request.

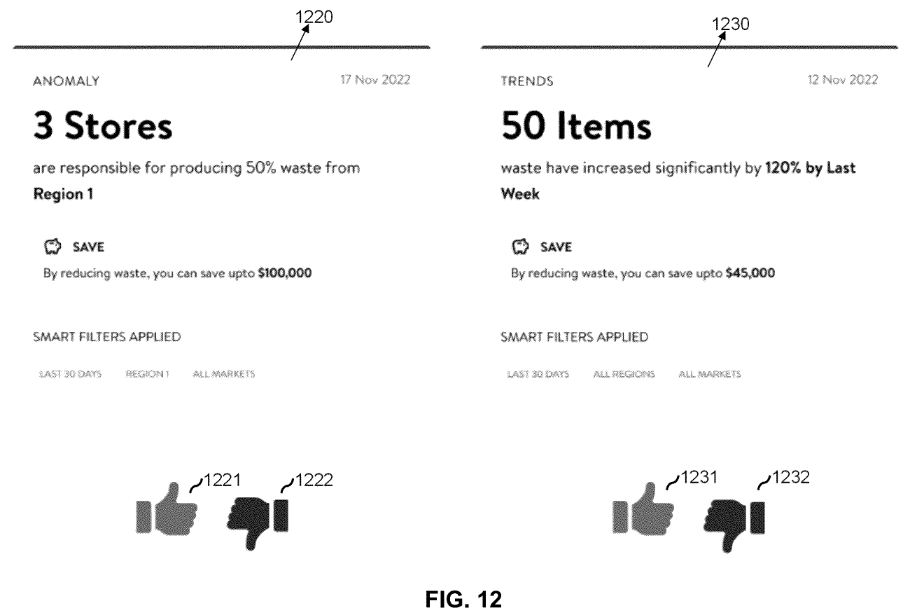

In some embodiments, the top 5 insights selected can be displayed in the form of cards. FIG. 12 illustrates exemplary cards 1220, 1230 displaying generated insight data, in accordance with some embodiments of the present teaching. The cards 1220, 1230 may be displayed in a same user interface or different user interfaces. As shown in FIG. 12, each of the cards 1220, 1230 shows a corresponding natural language insight, with filter combinations used to arrive at that insight highlighted below the insight. In addition, the card 1220 includes a like button 1221 and a dislike button 1222; the card 1230 includes a like button 1231 and a dislike button 1232. As such, a user can provide feedback by clicking the like or dislike button depending on whether the insight is helpful to the user. In some embodiments, the users' feedback may be used to update the state of the reinforcement learning model, ensuring right dimensions are selected going forward.

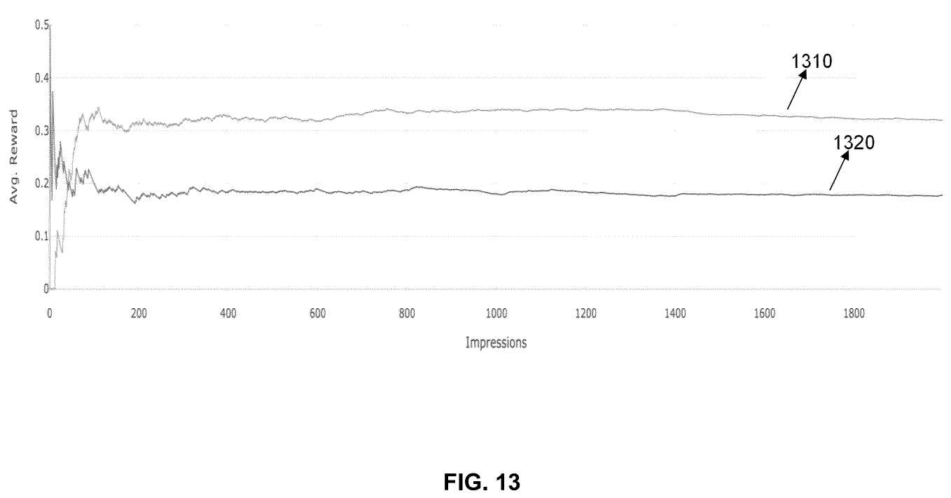

FIG. 13 illustrates a performance comparison between different sampling methods during reinforcement learning, in accordance with some embodiments of the present teaching. In this example, the reward rate for anomaly is set to be 0.08; the reward rate for trend is set to be 0.14; and the reward rate for correlation is set to be 0.32. A Thompson sampling 1310 could pick up these specified reward rate information based on its past learnings.

In some embodiments, a reinforcement learning model using the Thompson sampling 1310 learns from past feedback data to predict the success rates of the three dimensions. At the beginning, all of the three dimensions are assigned with an equal success rate, which means the reinforcement learning engine 720 can randomly choose 5 records out of the 15 records in the above examples for the first round or first impression. But after the reinforcement learning engine 720 obtains and incorporates user feedback with likes and dislikes, different success rates are assigned or updated to different insight dimensions. Eventually after a large enough number of impressions, the reinforcement learning engine 720 can select the top 5 records out of the 15 records according to the three dimensions' respective updated success rates, which will become closer and closer to their respective pre-set or true reward rates.

In some embodiments, the Thompson sampling is used to estimate a Beta distribution for each insight dimension, and sample each insight dimension according to the Beta distribution. For example, the system can sample 5 times to generate the top 5 data records out of the 15 data records. During each time, the system can sample from the Beta distributions, and choose an insight dimension whose Beta distribution gives the highest sampling output.

In some embodiments, two parameters, alpha and beta, may be used for the Beta distribution of each insight dimension, where alpha refers to the number of likes, and beta refers to the number of dislikes. Based on feedback data including likes and dislikes, the parameters of each Beta distribution are updated to adjust the likelihood of sampling the corresponding insight dimension. For example, when alpha, which is the number of likes, for correlation is the highest among the three insight dimensions, the likelihood of the sampled output from correlation's Beta distribution will be higher than the sampled outputs from the other two dimensions' Beta distributions. As such, a data record with correlation insight gets selected. By modifying alpha and beta in each Beta distribution, the reinforcement learning model automatically considers both exploit (by sampling the dimension group with highest succuss rate) and explore (by sampling other dimension groups), without a need of external input regarding a ratio of exploit and explore.

In some embodiments, the reinforcement learning model is trained to maximize an average reward, computed based on a number of likes per insight. As such, a well-trained reinforcement learning model can be used to sample the insight dimensions with sampling likelihood consistent with the likelihood of receiving likes (or reward rate). That is, a higher reward rate for a given dimension will lead to a proportionally higher sampling rate for the given dimension. The weights given to different dimensions during sampling (e.g. selecting 5 out of 15, or selecting L out of M*N), will be proportional to their respective reward rates, after the reinforcement learning model is trained with the Thompson sampling.

As shown in FIG. 13, after a large enough number of impressions, the average reward for the Thompson sampling 1310 is about 0.32, which is higher than the average reward for the random sampling 1320 that is about 0.18. This is because the Thompson sampling 1310 can leverage past knowledge to produce a much higher average reward as compared to the random sampling 1320, which always randomly selects from the three dimensions without considering any feedback. As the user feedback is collected from a large number of representative users, the reinforcement learning model can select representative filter combinations to generate insights interesting to all users.

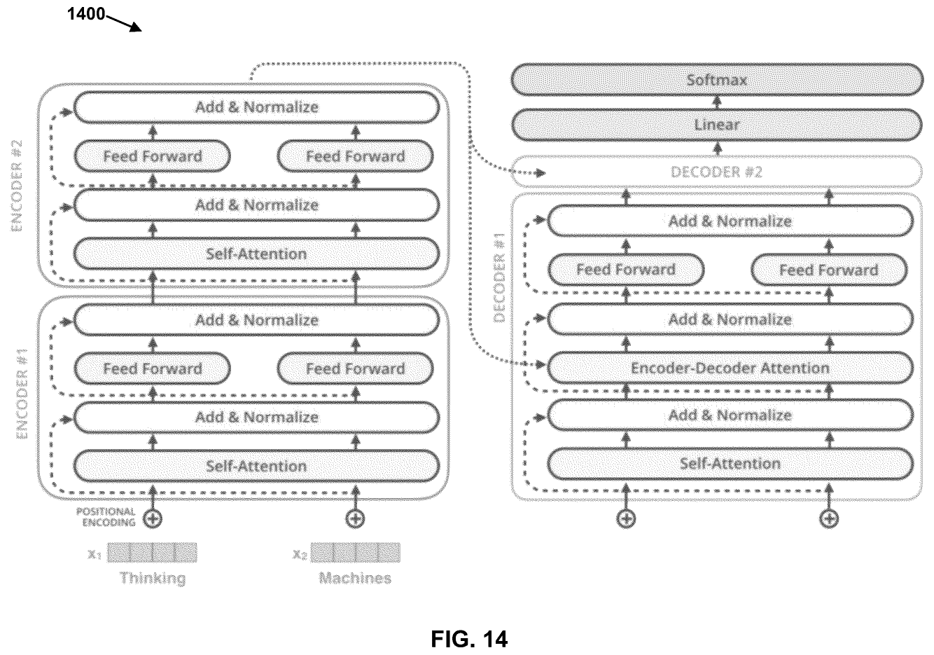

FIG. 14 illustrates an exemplary architecture 1400 of a natural language generation model, in accordance with some embodiments of the present teaching. In some embodiments, the architecture 1400 is built based on a text-to-text transfer transformer (T5) model, which is a transformer based complete encoder-decoder model and trained on common crawl web extracted text. In some embodiments, transfer learning is done on this model using automatically created synthetic corpus, re-training a total of about 272 million parameters in different blocks of the architecture 1400. In some embodiments, the natural language generation model is also updated based on user feedback, where one or more parameters in the architecture 1400 are modified with a different value or different weight. In some embodiments, the max_length and num_beams hyperparameters are tweaked to help overcoming the issue of abrupt truncation of predicted sentence, when generating or updating the natural language generation model. In some embodiments, the max_length hyperparameter indicates a maximum length the generated tokens can have. In some embodiments, the num_beams hyperparameter indicates a number of beams for beam search, e.g. num_beams=1 meaning a greedy search with no beam search. These two parameters can control the length of generated insights and the way words are selected for natural language generation.

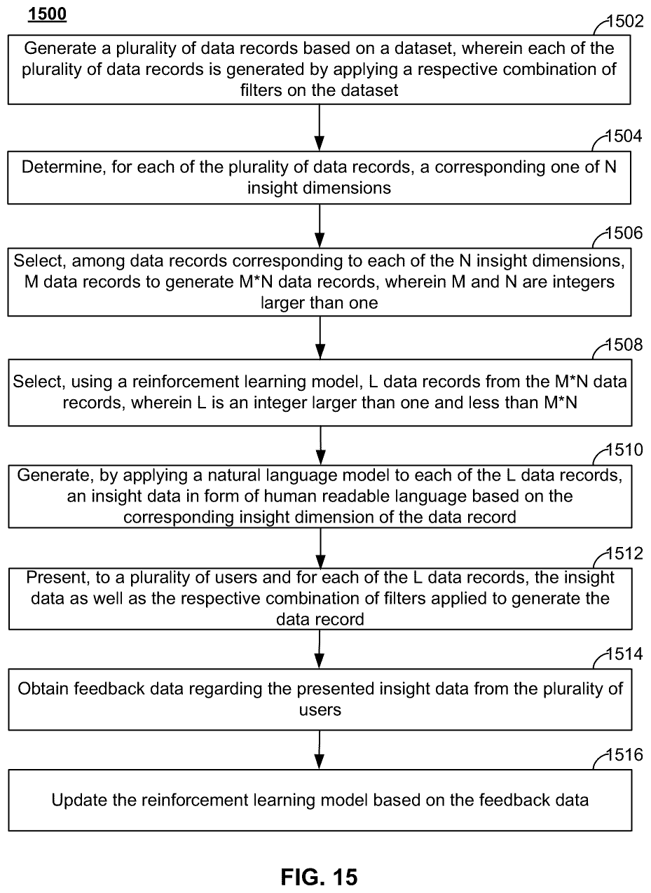

FIG. 15 is a flowchart illustrating an exemplary method 1500 for automatically generating and presenting insight data, in accordance with some embodiments of the present teaching. In some embodiments, the method 1500 can be carried out by one or more computing devices, such as the insight generation computing device 102 and/or the cloud-based engine 121 of FIG. 1. Beginning at operation 1502, a plurality of data records are generated based on a dataset. Each of the plurality of data records is generated by applying a respective combination of filters on the dataset. At operation 1504, a corresponding one of N insight dimensions is determined for each of the plurality of data records. At operation 1506, M data records are selected among data records corresponding to each of the N insight dimensions, to generate M*N data records. M and N are integers larger than one.

Using a reinforcement learning model, L data records are selected at operation 1508 from the M*N data records. L is an integer larger than one and less than M*N. By applying a natural language model to each of the L data records, an insight data is generated at operation 1510 in form of human readable language based on the corresponding insight dimension of the data record. At operation 1512, the insight data for each of the L data records is presented, together with the respective combination of filters applied to generate the data record, to a plurality of users. At operation 1514, feedback data regarding the presented insight data is obtained from the plurality of users. At operation 1516, the reinforcement learning model is updated based on the feedback data.

Although the methods described above are with reference to the illustrated flowcharts, it will be appreciated that many other ways of performing the acts associated with the methods can be used. For example, the order of some operations may be changed, and some of the operations described may be optional.

The disclosed system and method can automatically identify filter combinations or sections of data where the user needs to focus on, and provide interpretable and actionable insights from tabular data using natural language generation models. The system can generate critical insights by holistically looking at multiple dimensions (e.g. anomaly, trend and correlation) of various features. The system may utilize a self-learning framework that adapts based on users' feedback to provide more meaningful insights. As such, the system can guide end users instantly to the most critical sections of data and provide interpretable insights, which otherwise would have taken considerable time and effort. This avoids a long learning curve associated with getting familiarized to a new dashboard and identifying critical elements for new users, and provides a starting point to accelerate the workflow for experienced users by providing them with more investigation time. In some embodiments, users can save on an average about three hours while looking for critical insights from a dashboard, after using the disclosed method. In some embodiments, the disclosed system can be integrated into an AI system that can automatically convert any table, chart or dashboard data, into actionable and interpretable insight cards.

The disclosed system and method can be applied to any dashboard on any dataset, e.g. datasets related to chatbot analytics, fraud prevention, loss prevention, waste, advertisements, etc. Before applying the disclosed method to a new dataset, one or more models may be re-trained. For example, reference sentences used to train or tune a natural language generation model may vary depending on the use case. Reference sentences for a waste dashboard can be very different from reference sentences for a fraud prevention dashboard. In addition, features used to detect an insight dimension might be different for different use cases. For example, features like customer refund average and cancellation rate can be used train an isolation forest model and detect an anomaly from a transaction fraud prevention dataset. But other features like waste due to discount and waste due to expiration can be used to train an isolation forest model and detect an anomaly from a waste dataset.

In some embodiments, the disclosed system and method can be applied to a data product, like Walmart Luminate™,℠, to give merchants and suppliers access to rich and aggregated customer insights that can enable their smarter and faster decision-making. By re-training one or more models, the disclosed system and method can automatically generate insight data in form of natural language. The insight data may be related to shopper behavior, customer perception, and/or channel performance, to help merchants and suppliers to easily understand the customers' needs and wants. Different suitable sets of reference sentences may be automatically generated to train or tune a natural language generation model for insights related to shopper behavior, customer perception, and channel performance, respectively. Different features may be identified for training an anomaly detection model and detecting an anomaly from datasets related to shopper behavior, customer perception, and channel performance, respectively. Based on the disclosed system and method, a user can efficiently and effectively leverage a service like Walmart Luminate™,℠ to obtain insights for category reviews, category planning, category assessment, assortment optimization, trade activity optimization, trade planning, multiple brand optimization, white space planning, marketing planning, category and channel strategy, portfolio optimization, etc.

In some embodiments, the disclosed system and method can be applied to an advertising platform, like Walmart Connect®, to help brand advertisers and sellers meaningfully connect with customers on their shopping journey, online or in-store, to find the right product or discover a new one. By re-training one or more models, the disclosed system and method can automatically generate insight data in form of natural language. The insight data may be related to search advertisements, display advertisements, in-store advertisements, brand interactions, and advertisement impact measurements, to help marketers to create more refined, relevant and measurable advertising campaigns, which can be adapted on-the-fly to changing circumstances and real-time performance. Different suitable sets of reference sentences may be automatically generated to train or tune a natural language generation model for insights related to search advertisements, display advertisements, in-store advertisements, brand interactions, and advertisement impact measurements, respectively. Different features may be identified for training an anomaly detection model and detecting an anomaly from datasets related to search advertisements, display advertisements, in-store advertisements, brand interactions, and advertisement impact measurements, respectively. Based on the disclosed system and method, seller and advertisers can efficiently and effectively leverage a service like Walmart Connect® to accelerate their connections to customers in a closed-loop, omnichannel environment.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
generate a plurality of data records based on a dataset, wherein each of the plurality of data records is generated by applying a respective combination of filters on the dataset,
select, using a reinforcement learning model, at least one data record from the plurality of data records based on at least one insight dimension,
generate, by applying a natural language model to each of the at least one data record, an insight data in form of human readable language based on the at least one insight dimension, and
transmit, for each of the at least one data record, the insight data to be presented to a user together with the respective combination of filters applied to generate the data record.

2. The system of claim 1, wherein:
each of the plurality of data records is generated by aggregating all data points, in the dataset, falling under the respective combination of filters; and
different data records are generated by applying different respective combinations of filters.

3. The system of claim 1, wherein the at least one data record is selected based on:
determining, for each of the plurality of data records, a corresponding one of N insight dimensions;
selecting, among data records corresponding to each of the N insight dimensions, M data records to identify M*N data records, wherein M and N are integers larger than one; and
selecting, using the reinforcement learning model, L data records from the M*N data records, wherein L is an integer larger than one and less than M*N.

4. The system of claim 3, wherein:
the N insight dimensions comprise: anomaly, trend and correlation;
a data record is determined to be an anomalous data record corresponding to an anomaly insight dimension when an isolation forest model is used to detect an abnormal value of a feature of the anomalous data record compared to the feature of other data records;
a data record is determined to be a trend data record corresponding to a trend insight dimension when a change point detection model is used to detect a continuous behavior change of a feature of the trend data record from a previous time period to a current time period; and
a data record is determined to be a correlation data record corresponding to a correlation insight dimension when a t-test model is used to detect multiple features, of the correlation data record, which are highly correlated in a same time period compared to a threshold.

5. The system of claim 3, wherein selecting the L data records comprises:
determining, based on the reinforcement learning model, a reward as a proportion of cases leading to a true risk feedback from users over a past time period, wherein the reward is determined based on likes and dislikes in the users' previous feedbacks; and
selecting, using the reinforcement learning model, top L data records that the users will give a maximum proportion of likes.

6. The system of claim 3, wherein selecting the L data records comprises:
determining, for each of the M*N data records, a probability of selection from a corresponding fitted Beta distribution; and
selecting, using the reinforcement learning model, top L data records corresponding to top L probabilities of selection.

7. The system of claim 3, wherein the at least one processor is further configured to:
perform a linearization on each of the L data records to generate L linearized data records, wherein each linearized data record includes textual tags that identify cell value and corresponding attribute of the linearized data record.

8. The system of claim 7, wherein the insight data is generated based on:
applying the natural language model to each linearized data record to generate a natural language description based on an insight dimension corresponding to the linearized data record, wherein the natural language description includes one or more interpretable insights in human readable form based on content of the linearized data record.

9. The system of claim 1, wherein the at least one processor is further configured to:
receive feedback data from a plurality of users who have viewed the insight data; and
update one or more hyperparameters of the reinforcement learning model based on proportions of likes and dislikes in the feedback data.

10. A computer-implemented method, comprising:
generating a plurality of data records based on a dataset, wherein each of the plurality of data records is generated by applying a respective combination of filters on the dataset;
selecting, using a reinforcement learning model, at least one data record from the plurality of data records based on at least one insight dimension;
generating, by applying a natural language model to each of the at least one data record, an insight data in form of human readable language based on the at least one insight dimension; and
transmitting, for each of the at least one data record, the insight data to be presented to a user together with the respective combination of filters applied to generate the data record.

11. The computer-implemented method of claim 10, wherein:
each of the plurality of data records is generated by aggregating all data points, in the dataset, falling under the respective combination of filters; and
different data records are generated by applying different respective combinations of filters.

12. The computer-implemented method of claim 10, wherein selecting the at least one data record comprises:
determining, for each of the plurality of data records, a corresponding one of N insight dimensions;
selecting, among data records corresponding to each of the N insight dimensions, M data records to identify M*N data records, wherein M and N are integers larger than one; and
selecting, using the reinforcement learning model, L data records from the M*N data records, wherein L is an integer larger than one and less than M*N.

13. The computer-implemented method of claim 12, wherein:
the N insight dimensions comprise: anomaly, trend and correlation;
a data record is determined to be an anomalous data record corresponding to an anomaly insight dimension when an isolation forest model is used to detect an abnormal value of a feature of the anomalous data record compared to the feature of other data records;
a data record is determined to be a trend data record corresponding to a trend insight dimension when a change point detection model is used to detect a continuous behavior change of a feature of the trend data record from a previous time period to a current time period; and
a data record is determined to be a correlation data record corresponding to a correlation insight dimension when a t-test model is used to detect multiple features, of the correlation data record, which are highly correlated in a same time period compared to a threshold.

14. The computer-implemented method of claim 12, wherein selecting the L data records comprises:
determining, based on the reinforcement learning model, a reward as a proportion of cases leading to a true risk feedback from users over a past time period, wherein the reward is determined based on likes and dislikes in the users' previous feedbacks; and
selecting, using the reinforcement learning model, top L data records that the users will give a maximum proportion of likes.

15. The computer-implemented method of claim 12, wherein selecting the L data records comprises:
determining, for each of the M*N data records, a probability of selection from a corresponding fitted Beta distribution; and
selecting, using the reinforcement learning model, top L data records corresponding to top L probabilities of selection.

16. The computer-implemented method of claim 12, further comprising:
performing a linearization on each of the L data records to generate L linearized data records, wherein each linearized data record includes textual tags that identify cell value and corresponding attribute of the linearized data record.

17. The computer-implemented method of claim 16, wherein generating the insight data comprises:
applying the natural language model to each linearized data record to generate a natural language description based on an insight dimension corresponding to the linearized data record, wherein the natural language description includes one or more interpretable insights in human readable form based on content of the linearized data record.

18. The computer-implemented method of claim 10, further comprising:
receiving feedback data from a plurality of users who have viewed the insight data; and
updating one or more hyperparameters of the reinforcement learning model based on proportions of likes and dislikes in the feedback data.

19. A non-transitory computer readable medium having instructions stored thereon, wherein the instructions, when executed by at least one processor, cause at least one device to perform operations comprising:
generating a plurality of data records based on a dataset, wherein each of the plurality of data records is generated by applying a respective combination of filters on the dataset;
selecting, using a reinforcement learning model, at least one data record from the plurality of data records based on at least one insight dimension;
generating, by applying a natural language model to each of the at least one data record, an insight data in form of human readable language based on the at least one insight dimension; and
transmitting, for each of the at least one data record, the insight data to be presented to a user together with the respective combination of filters applied to generate the data record.

20. The non-transitory computer readable medium of claim 19, wherein selecting the at least one data record comprises:
determining, for each of the plurality of data records, a corresponding one of N insight dimensions;
selecting, among data records corresponding to each of the N insight dimensions, M data records to identify M*N data records, wherein M and N are integers larger than one; and
selecting, using the reinforcement learning model, L data records from the M*N data records, wherein L is an integer larger than one and less than M*N.
